(19) United States
(12) Patent Application Publication
(10) Pub. No.: US 2009/0183436 A1
(43) Pub. Date: Jul. 23, 2009

(54) TRIM PANEL RETENTION SYSTEM

(75) Inventor: Alan G. Dry, Grosse Pointe Woods, MI (US)

Correspondence Address: BROOKS KUSHMAN P.C.;INTL. AUTOMOTIVE COMPONENTS GROUP, 1000 TOWN CENTER, TWENTY-SECOND FLOOR, SOUTHFIELD, MI, 48075, US

(73) Assignee: International Automotive Components Group North America, Inc., Dearborn, MI (US)

(21) Appl. No.: 12/345,945

(22) Filed: Dec. 30, 2008

Related U.S. Application Data
(60) Provisional application No. 61/022,712, filed on Jan. 22, 2008.

(51) Int. Cl. B60J 5/04

(52) U.S. Cl. 49/502; 49/506

(57) ABSTRACT

A trim panel retention system for a vehicle interior includes serviceable trim clips holding trim panel to a base panel in an operating condition. A secondary retaining member extends from the trim panel and passes through a secondary retention opening in the base panel, overlapping the base panel adjacent to the secondary retention opening and spaced from the base panel. If the trim clips become disengaged due a collision and the trim panel separates from the base panel, the secondary retaining member engages the base panel to limit movement of the trim panel.

### CROSS-REFERENCE TO RELATED APPLICATIONS

This application claims the benefit, under 35 USC §119(e), of U.S. Provisional Application Ser. No. 61/022,712 filed Jan. 22, 2008, which is hereby incorporated herein by reference.

### BACKGROUND

1. Field of the Invention

The invention relates to trim panels used in automotive vehicles and more specifically to a retention system for trim panels.

2. Background Art

Automotive vehicle interiors are commonly composed of one or more plastic or composite trim panels attached to base or substrate panels using threaded fasteners, snap-in clips, or a combination of both. This trim/substrate construction is necessary to permit the use of different materials for the various components of the vehicle interior (as may be dictated by appearance, feel, cost, strength, or other considerations) and also to allow the assembly of the vehicle interior components in a cost-effective and high-quality fashion.

In the manufacture and assembly of a vehicle door, for example, it is known to provide a base or substrate door panel which serves as the attachment point for components such as power window regulators, audio speakers, door latch release handles, electric control switch boxes, and the like. This base door panel, sometimes known as a modular door, may be built up at a location remote from the vehicle final assembly facility and shipped to the final assembly facility where it is attached to the metal door structure as part of the assembly line process. One or more interior trim panels may be attached to the base door panel surface that is to face the passenger compartment, either before or after this base panel/door assembly step on the assembly line.

A trim panel providing an armrest or side bolster may be fabricated as a separate component and assembled to the base door panel after the base door panel is attached to the metal door structure. The armrest/bolster trim panel may be attached using clips that snap into engagement with mating features on the base panel during assembly and can later be disengaged (“un-snapped”) from the base panel to allow access to electrical and/or mechanical components for any inspection, repair, and servicing that may be necessary. This sort of clip that is intended to permit multiple engagements/disengagements over the operating life of the vehicle is referred to herein as a serviceable clip.

In some types of impacts between a vehicle and another object, it is possible for a trim panel attached by servicable clips to be dislodged from its normal operating position. This may be desirable because if the trim panel were more securely attached to the base panel (by threaded fasteners, for example) the trim panel might fracture and present a rough or sharp edge to vehicle occupants. Such fracturing is more likely to be prevented if the trim panel is allowed to detach from the base panel and therefore remain in a single piece. If the trim panel does become dislodged due to an impact, though, it is preferable that it be restrained against excessive movement within the passenger compartment.

### SUMMARY OF THE DISCLOSURE

According to a first embodiment of the invention, a trim panel retention system for an automotive vehicle interior comprises a base panel having a plurality of clip sockets and at least one secondary retention opening, and a trim panel overlaying the base panel in an operating condition. A plurality of serviceable trim clips extend from the trim panel into engagement with their respective clip sockets to retain the trim panel and base panel together in the operating condition. A secondary retaining member extends from the trim panel and passes through the secondary retention opening, overlapping the base panel adjacent to the secondary retention opening and spaced from the base panel. Upon movement of the trim panel away from the base panel, such as may occur if the vehicle is involved in a collision, the overlapping portion of the secondary retention member contacts the base panel to restrain the trim panel against movement beyond a retention position.

According to another feature of the embodiment disclosed herein, the secondary retaining member comprises a hook portion that is undersized relative to the secondary retention opening such that, during an assembly process, the hook portion may be inserted through the secondary retention opening with no substantial resistance such as may impede the assembly process or degrade the functioning of the retention features.

According to another feature of the embodiment disclosed herein, the trim panel has a first engagement feature and the base panel has a second engagement feature, the first and second engagement features being located to matingly engage one another upon movement of the trim panel to the retention position. This provides additional assurance that the trim panel will remain restrained in the retention position, and will not move to a position that would allow the secondary retaining member to slip out of the secondary retaining opening.

According to another feature of the embodiment disclosed herein, the secondary retaining member comprises an indexing surface that contacts an edge of the secondary retention opening when the secondary retaining member is inserted into the secondary retention opening. The contact between the indexing surface and the edge of the opening positions at least one pair of mating serviceable trim clips and clip sockets in registry with one another. During assembly of the trim panel to the base panel the contact between the indexing surface and secondary retaining opening inner edge provides tactile feedback to an assembler that the parts are in the correct pre-assembly position, thereby contributing to faster and more accurate manual assembly.

### BRIEF DESCRIPTION OF THE DRAWINGS

FIG. 1 is a partial perspective view of a passenger vehicle showing a driver's door with a bolster trim panel and a door base panel assembled in an operating condition;

FIG. 2 is a perspective view of the bolster trim panel and door base panel of FIG. 1 in a pre-assembly condition;

FIG. 3 is a cross-sectional view taken along line 3-3 of FIG. 2 and showing a portion of the trim panel and base panel in a first assembly stage;

FIG. 4 is a cross-sectional view showing a portion of the trim panel and base panel in a second assembly stage;

FIG. 5 is a cross-sectional view showing a portion of the trim panel and base panel attached to one another in an operating condition; and

FIG. 6 is a cross-sectional view showing a portion of the trim panel and base panel attached to one another in a detached condition; and.

### DETAILED DESCRIPTION OF EMBODIMENT(S) OF THE INVENTION

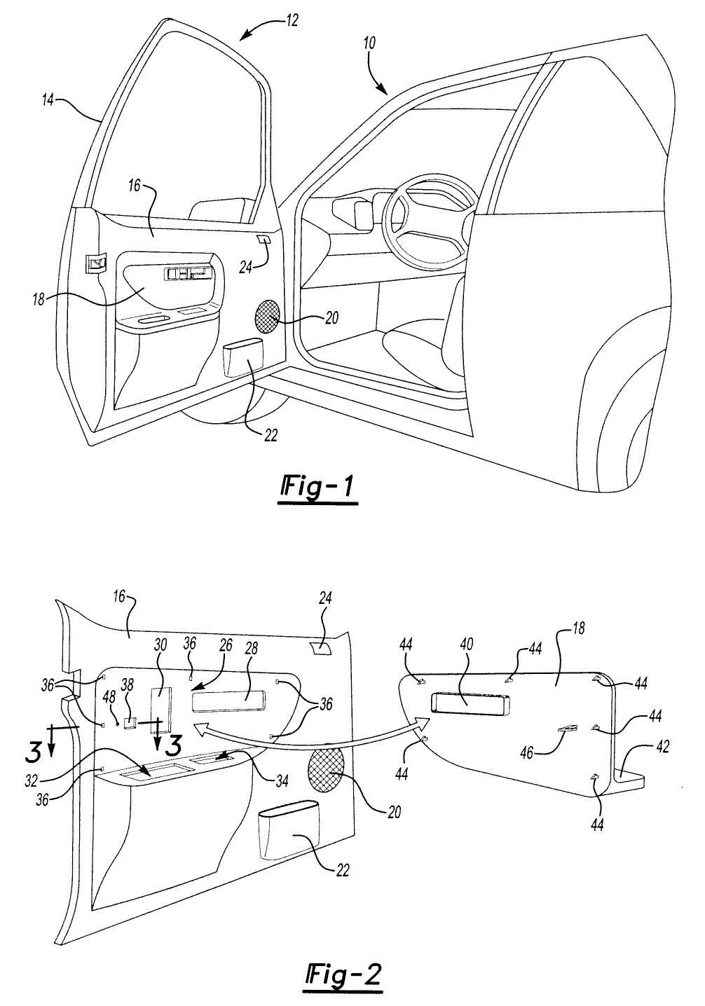

FIG. 1 depicts a passenger vehicle comprising a body structure 10 and a door assembly 12 in an open position relative to the body. Door assembly 12 generally comprises a metal primary door structure 14 that may be attached to the body structure 10 by hinges (not shown), an interior base panel 16, and a bolster trim panel 18. Door base panel 16 is attached to primary door structure 14 by appropriate fastening means (not shown), such as threaded or press-in fasteners, so that the front surface of door base panel 16 visible in FIG. 1 faces the interior of the vehicle passenger compartment. There may be any number of intermediate structural layers and/or components between door base panel 16 and primary door structure without departing from the scope of the present invention. Door base panel 16 may be made from an appropriate plastic or reinforced composite material as is well known in the automotive interiors art. At least some portion of the front of door base panel 16 constitutes a so-called Class-A surface which is visible to and touchable by vehicle occupants, and is therefore of optimal aesthetic appearance and high surface quality. Door base panel 16 may include features such as a speaker mounting receptacle 20, a lower pocket 22, and a defog vent 24.

Referring now to FIG. 2, door base panel 16 and bolster trim panel 18 are shown detached from the rest of door assembly 12 and separated from one another. A bolster recess 26 is located generally centrally in door base panel 16 and includes a door latch opening 28, a regulator service opening 30, a pull cup opening 32, and a window control mount opening 34. As is well known in the art, openings 28, 30, 32, and 34 provide mounting locations and/or service access holes for various door components (not shown), as indicated by their respective names. A plurality of trim clip sockets 36 are positioned in the bolster recess 26 to retain bolster trim panel 18 in the manner discussed below. A secondary retention opening 38 is also located within the perimeter of bolster recess 26.

Bolster trim panel 18 may be formed of a plastic or composite material, for example by injection molding, and one or more areas may be covered by a cover stock material. Bolster trim panel 18 fits over bolster recess 26 when in the assembled or operating condition as shown in FIG. 1. Bolster trim panel 18 includes a latch handle access opening 40 passing through the generally vertical portion thereof and a generally horizontal armrest shelf portion 42. As best seen in FIG. 2, a plurality of servicable trim clips 44 extend from the surface of bolster trim panel 18 that faces and fits against door base panel 16 when in the operating condition. This surface of bolster trim panel 18 that faces door base panel 16 is referred to herein as the rear surface. Trim clips 44 are disposed, in a pattern that matches the arrangement of trim clip sockets 36 on door base panel 16.

Trim clips 44 and clip sockets 36 have mating geometries that allow the clips 44 to be pressed into engagement with the sockets 36 to hold bolster trim panel 18 in secure, but not permanent, connection with door base panel 16. Any of the myriad types of mating press-in fasteners that are well-known in the automotive interiors art may be used. Such servicable clips are intended to permit the connected parts to be disengaged from one another and reattached one or more times, thereby allowing a trim panel to be removed for inspection and/or servicing of components located between the attached parts. In the preferred embodiment, trim clips 44 are molded or otherwise formed integrally with bolster trim panel 18 but the trim clips 44 may be separately formed fasteners that are inserted or driven through holes in the bolster trim panel 18.

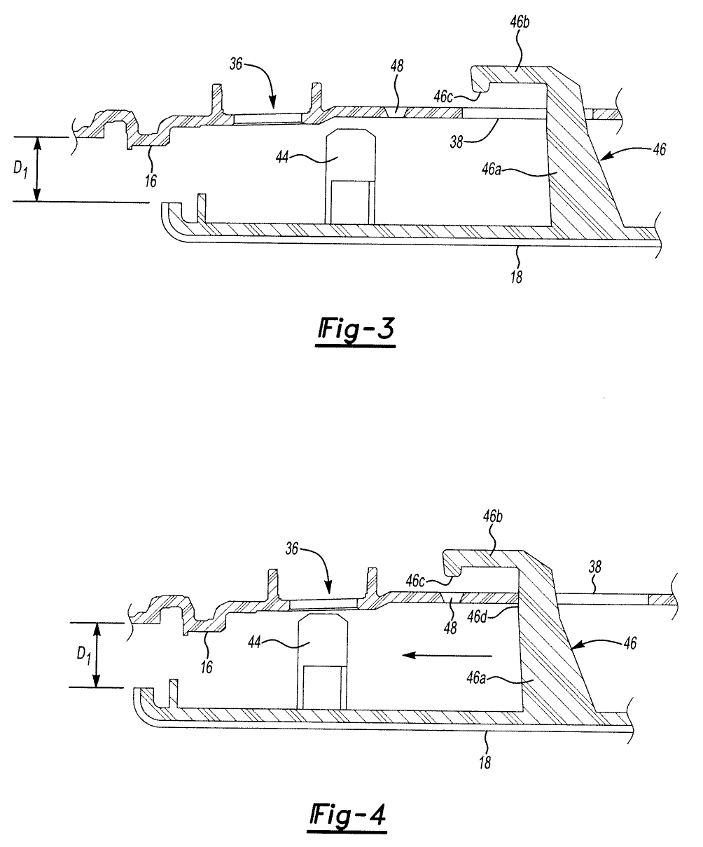

A secondary retaining member 46 extends from the rear surface of bolster trim panel 18 and, as best seen in FIGS. 3-6, includes a shank portion 46a extending rearwardly from the rear surface of bolster trim panel 18 and a hook portion 46b extending generally perpendicular from the shank 46a. Hook portion 46b may include a first engagement feature which, in this embodiment, is a protrusion 46c extending back toward the rear surface of bolster trim panel 18. As explained in greater detail below, the protrusion 46e can provide additional retention for the bolster trim panel 18.

In FIG. 3, door base panel 16 and bolster trim panel 18 are shown during a first stage of assembling the two components. In FIG. 3, some features, such as the armrest shelf portion 42 seen in FIG. 2, are removed for clarity. In the particular type of door construction used herein to illustrate embodiments of trim retention system, this step occurs after door base panel 16 has been fastened to the primary door structure 14 and various mechanical and electrical components included in the door assembly have been secured to the door base panel 16. Bolster trim panel 18 is positioned relative to door base panel 16 to insert secondary retaining member 46 through secondary retaining opening 38 so that hook portion 46b is beyond (rearward of) the rear surface of the door base panel 16. As is readily seen, there is a stand-off distance D₁ between the portions of door base panel 16 and bolster trim panel 18 that will be in contact with one another when the panels are joined with one another in the operating condition, and servicable trim clips 44 (only one of which is shown in the partial view of FIG. 3) are not yet aligned with their respective sockets 36.

As is apparent from FIG. 3, hook portion 46b is undersized relative to secondary retaining opening 38, meaning that the hook portion 46b is small enough to pass through the secondary retaining opening without substantial interference between the two components. Substantial interference is defined as that degree of physical contact between the two components that would: a) adversely effect the speed, ease, or accuracy of the assembly process; and/or b) result in physical deformation of hook portion 46a and/or door base panel 16 adjacent to secondary retention opening 38 to a degree that would degrade the strength, reliability, or repeatability of the desired retention functioning of the apparatus as described below in relation to FIG. 6.

FIG. 4 shows the next step in the assembly procedure in which the components have been moved to a pre-engagement position. To achieve the pre-engagement position, bolster trim panel 18 is moved generally parallel to door base panel 16 (to the left as viewed in FIG. 4) to place hook portion 46b in an overlapping position relative to the rear surface of the door base panel 16. In this context, the term “generally parallel” should be understood to mean along an axis that is within plus or minus approximately 30° of parallel to a plane containing the door base panel 16. In this depicted embodiment, this movement of bolster trim panel 18 is in a rearward direction with respect to the door assembly 12 and vehicle body 10, but the relative shapes of door base panel 16 and bolster trim panel 18 may dictate that movement to the pre-engagement position be in some other direction (forward, upward, downward, or any combination thereof) as required to assemble them to one another.

In the pre-engagement position shown in FIG. 4, all trim clips 44 are in registry with their respective sockets 36. The components of the trim retention system may be configured so that an indexing surface 46d on secondary retention member 46 contacts a mating indexing surface on door base panel 16 when trim clips 44 and sockets 36 are in registry. In the embodiment depicted, an inner edge of secondary retaining opening 38 serves as the mating indexing surface. This indexing/registry configuration contributes to faster and more accurate manual assembly of the components because the contact between indexing surface 46d and secondary retaining opening 38 inner edge provides tactile feedback to an assembler that the parts are in the correct pre-assembly position.

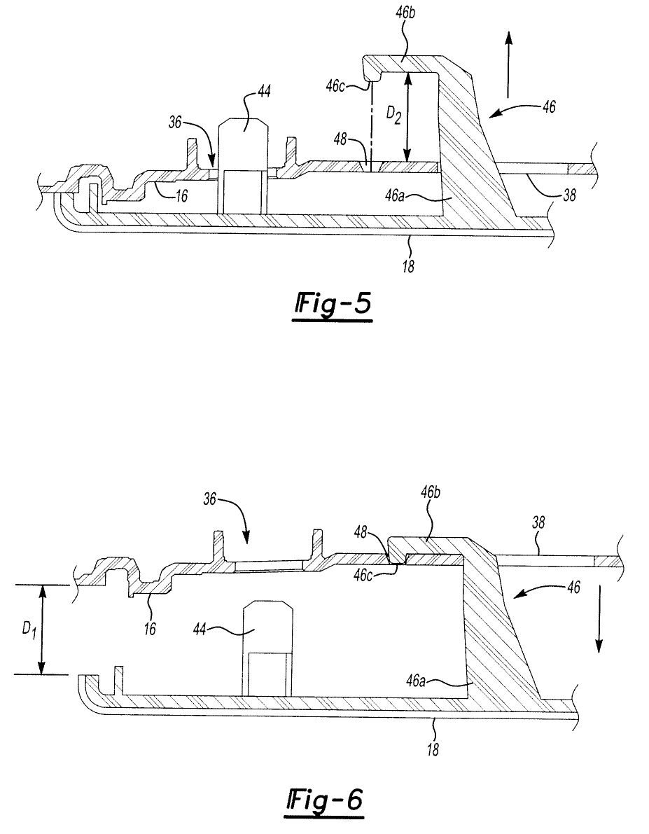

FIG. 5 shows the final step in the assembly procedure in which the components are engaged with one another in an operating condition. Bolster trim panel 18 has been urged toward door base panel 16 to snap servicable trim clips 44 into engagement with their respective sockets 36, and hook 46b is spaced from the rear surface of door base panel 16 by a retention distance D₂.

For normal inspection or servicing of interior components of door assembly 12, the assembly procedure described above may be reversed to separate bolster trim panel 18 from door base panel 16 and provide access to the bolster recess area 26. This is accomplished by first pulling, prying, or otherwise urging bolster trim panel 18 away from door base panel 16 so that trim clips 44 disengage or “un-snap” from the respective sockets 36. Bolster trim panel 18 is then moved laterally to the position shown in FIG. 4 so that hook 46b is clear of (no longer overlaps) door base panel 16, then pulled directly away from door base panel 16 to withdraw secondary retaining member 46 from secondary retaining opening 38.

FIG. 6 shows bolster trim panel 18 in a retention position relative to door base panel 16 such as it may assume when an impact between the vehicle an another object has caused trim clips 44 to detach from engagement with sockets 36, thus allowing bolster trim panel 18 to move away from door base panel 16. Because secondary retaining member 46 overlaps door base panel 16, this movement to the retention position brings hook 46b into contact with the rear surface of door base panel 16. This contact between secondary retaining member 46 and door base panel 16 restrains bolster trim panel 18 against moving away from the door base panel 16 any farther than the retention distance D₂. In one possible embodiment of the invention, a female feature such as a hole 48, constituting a second engagement feature, is formed in door base panel 16 adjacent to secondary retaining opening 38. Hole 48 is located where it will engage protrusion 46c when bolster trim panel 18 moves to the retention position. This engagement between the male feature or protrusion 46c and the female feature or hole 48 gives further assurance that bolster trim panel 18 will not move to a position that would allow secondary retaining member 46 to slip out of secondary retaining opening 38. There are many different mating features that could be provided on secondary retaining member 46 and/or door trim panel 18 and/or door base panel 16 that would achieve the same result, all of which are within the scope of this feature of the present invention. For example, hole 48 may be replaced by a recess or by a second protrusion formed on the rear surface of door base panel 16 such that overlapping engagement between the two protrusions impedes movement of the bolster trim panel 18. Alternatively, the first engagement feature on hook 46b could be a male feature and the second engagement feature on door base panel 16 could be a female feature.

Secondary retaining member 46 and hook portion 46b in particular are of a sufficiently rigid construction (as achieved through the combination of materials properties and physical configuration) to retain bolster trim panel 18 in the retention position. It is also important that size of secondary retention opening 38 be large enough relative to secondary retaining member 46 that hook portion 46b can pass freely through the opening without deformation of the components to a degree that would degrade the strength, reliability, or repeatability of the desired retention functioning of the apparatus as described above. In the course of the service life of a vehicle a trim panel, such as the bolster trim panel disclosed, may need to be disassembled from and reassembled to a base panel several times to allow access to areas behind the trim panel. The retention components of the present invention are designed so that they are not stressed, deformed, deflected, or otherwise degraded during the disassembly/reassembly process, and so they retain their desired strength and functionality regardless of how may times the process is repeated.

While the invention trim retention system is described and depicted herein in relation to a door base panel and a bolster trim panel, it is to be understood that the inventive concepts may be applied to any interior trim panel that is attached to a base panel by servicable clips and that would benefit from a secondary retention feature.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A trim panel retention system for an automotive vehicle interior, the system comprising:
a base panel having at least one clip socket and at least one secondary retention opening;
a trim panel overlaying the base panel in an operating condition;
at least one serviceable trim clip extending from the trim panel and engageable with a respective at least one clip socket to retain the trim panel and base panel together in the operating condition; and
at least one secondary retaining member extending from the trim panel and passing through a respective at least one secondary retention opening, the secondary retaining member having a rigid hook portion in an overlapping relationship with the base panel and spaced from the base panel by a retention distance when in the operating condition such that upon movement of the trim panel away from the base panel the hook portion contacts the base panel to restrain against movement of the trim panel beyond the retention distance, and the hook portion being undersized relative to the secondary retention opening such that, during an assembly process, the hook portion may be inserted through the secondary retention opening with no substantial resistance and the trim panel subsequently moved relative to the base panel to place the hook portion in the overlapping relationship with the base panel.

2. The apparatus according to claim 1 wherein the at least one secondary retaining member comprises a first engagement feature and the base panel comprises a second engagement feature, the first and second engagement features located to matingly engage one another upon movement of the trim panel to the retention position.

3. The apparatus according to claim 2 wherein the first engagement feature comprises a male feature and the second engagement feature comprises a female feature.

4. The apparatus according to claim 1 wherein the secondary retaining member comprises an indexing surface for contacting a mating indexing surface of the base panel when the secondary retaining member is inserted into the secondary retention opening and positioning the at least one serviceable trim clip and the at least one clip socket in registry with one another.

5. The apparatus according to claim 4 wherein the mating indexing surface comprises an edge of the secondary retention opening.

6. The apparatus according to claim 1 wherein the secondary retaining member is formed integrally with the trim panel.

7. The apparatus according to claim 1 wherein the at least one serviceable trim clip is formed integrally with the trim panel.

8. The apparatus according to claim 1 wherein the trim panel is an armrest bolster and the base panel is door base panel.

9. A trim panel retention system for an automotive vehicle interior, the system comprising:
a base panel having a front surface, a rear surface, at least one clip socket, and at least one secondary retention opening;
a trim panel having a rear and a front surface;
at least one serviceable trim clip extending from the trim panel into engagement with the at least one clip socket to retain the trim panel and base panel together in an operating condition wherein the trim panel rear surface is adjacent the base panel front surface; and
at least one secondary retaining member extending from the trim panel and passing through the secondary retention opening, the secondary retaining member having a hook portion extending generally parallel to a portion of the base panel rear surface adjacent the secondary retention opening and spaced from the base panel rear surface by a retention distance, whereby the trim panel is movable to a retention position relative to the base panel wherein the at least one serviceable trim clip and the at least one clip socket are detached from one another and the hook portion contacts the base panel rear surface adjacent to the secondary retention opening to impede movement of the trim panel beyond the retention distance.

10. The apparatus according to claim 9 further comprising a first engagement feature on the hook portion and a second engagement feature on the base panel, the first and second engagement features located to matingly engage one another upon movement of the trim panel to the retention position.

11. The apparatus according to claim 10 wherein the first engagement feature comprises a male feature and the second engagement feature comprises a female feature

12. The apparatus according to claim 8 wherein the secondary retaining member comprises an indexing surface for contacting a mating indexing surface of the base panel when the secondary retaining member is inserted into the secondary retention opening and positioning the at least one serviceable trim clip and the at least one clip socket in registry with one another.

13. The apparatus according to claim 12 wherein the mating indexing surface comprises an edge of the secondary retention opening.

14. The apparatus according to claim 8 wherein the at least one serviceable trim clip is formed integrally with the trim panel.

15. The apparatus according to claim 8 wherein the secondary retaining member is formed integrally with the trim panel.

16. The apparatus according to claim 8 wherein the trim panel is an armrest bolster and the base panel is door base panel.

17. A method of securing a trim panel to a base panel of an automotive vehicle interior, the method comprising:
positioning a rear surface of the trim panel adjacent a front surface of the base panel such that at least one secondary retaining member extending from the trim panel is in registry with at least one secondary retention opening in the base panel;
moving the trim panel toward the base panel such that the at least one secondary retaining member is inserted through the at least one secondary retention opening;
moving the trim panel relative to the base panel to place the panels in a pre-engagement position wherein a hook portion of the secondary retaining member is in overlapping relationship to a rear surface of the base panel, and wherein at least one serviceable trim clip extending from the trim panel is in registry with at least one clip socket formed in the base panel; and
urging the trim panel toward the base panel to place the panels in an operating condition wherein the at least one serviceable trim clip is engaged with the at least one clip socket, and wherein the hook portion is spaced from the base panel rear surface by a retention distance.

18. The method of according to claim 17 wherein the step of moving the trim panel to the pre-engagement position comprises placing an indexing surface of the secondary retaining member in contact with an edge defining the secondary retention opening, contact between the indexing surface and the edge preventing movement to establish the pre-engagement.

19. The method of according to claim 17 wherein the step of moving the trim panel to the pre-engagement position comprises movement in a plane normal to a direction of movement in the step of moving the trim panel toward the base panel.
